(19) United States
(12) Patent Application Publication
(10) Pub. No.: US 2026/0320088 A1
(43) Pub. Date: Oct. 15, 2026

(54) RECURSIVE CONTENT GENERATION

(71) Applicant: Dell Products L.P., Round Rock, TX (US)

(72) Inventors: Fatemeh Azmandian, Raynham, MA (US); Ananda D. Siddacharya, Shrewsbury, MA (US); Amihai Savir, Newton, MA (US)

(21) Appl. No.: 19/180,058

(22) Filed: Apr. 15, 2025

(51) Int. Cl. G06F 16/3329

(52) U.S. Cl. CPC G06F 16/33295

(57) ABSTRACT

Responsive to a request to generate content, a computing system may instantiate a supervisor agent, a planner agent, a retrieval agent, a writer agent, and/or an editor agent. The supervisor agent may instruct the planner to generate, or modify, an outline to be used to generate, using a learning model, generated content portions that correspond to sections of the outline. The planner may generate the outline recursively. Based on the outline, the supervisor agent may instruct the retrieval agent to retrieve context content, section-by-section, according to the outline, and may instruct the writer to generate content, section-by-section, using a writer learning model. The writer may generate a portion of generated content recursively with respect to other portions of generated content to minimize duplication of content from portion-to-portion. The writer may generate each portion of generated content independently using a full token capability corresponding to the writer learning model.

### REFERENCE TO RELATED APPLICATION

The subject patent application is related to U.S. Patent Application No. ______, filed ______, and entitled “Generating content with a learning model agent using a structured template” (docket no. 141676.01/DELLP1502US), the entirety of which application is hereby incorporated by reference herein.

### BACKGROUND

The term ‘cloud’ may refer to a set, group, collection, or other plurality of computing resources, components, services, instances, collections, application, and the like that may be accessed by a computing resource, typically via a communication network (a communication network may also be referred to as a cloud). The term ‘cloud’ is typically used in reference to the computing resources without referencing specific items that make up the cloud resources when discussing computing functionality from the perspective of a computing resource that may make use of the functionality.

A cloud computing service provider may make available various computing resources, for example, software as a service, virtual machines, storage, bare metal computing hardware, or even a complete enterprise's infrastructure and development platforms, over a communication network. A cloud services provider may make a public cloud computing resource available to users over a publicly accessible network, such as the Internet. A private cloud computing resource is typically available or accessible only by a given customer, such as an enterprise and its employees. Computing resources may be provided from an enterprise's own on-premises data center or from a data center operated by an independent (e.g., independent from the enterprise customer) cloud services provider. A hybrid cloud may connect an organization's private cloud services and resources of public clouds into an infrastructure that facilitates the organization's applications and workloads in a manner that balances the maximizing of performance and the minimizing of costs across public and private cloud computing resources.

Computing resources that make use of, that are based on, that facilitate, or that otherwise make available artificial intelligence learning models, for example language learning models or large learning models, may be facilitated by a single computing system, multiple computing systems, or cloud services computing systems that may be operated by a private entity or that may be provided by a public computing services entity for use by a private entity. Context information may be applied to a language learning model via input information that may be referred to as prompt information with respect to the language model.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an example embodiment a method may comprise, responsive to at least one generated content request to generate at least one generated content portion, generating, by at least one computing system comprising at least one processor, at least one content primitive comprising at least one content portion indication indicative of at least one content portion to be used to generate the at least one generated content portion and at least one template indication indicative of at least one template to be used to generate the at least one generated content portion. Responsive to the at least one generated content request, the method may further comprise converting, by the at least one computing system according to at least one standardized data format, the at least one template to result in at least one standardized template portion. The method may further comprise applying, by the at least one computing system according to the at least one standardized template portion, the at least one content portion to at least one learning model to result in the at least one generated content portion.

In an example embodiment, the at least one generated content portion may be generated according to the at least one standardized template portion.

In an example embodiment, the at least one template may comprise at least one template information section. The at least one generated content portion may comprise at least one generated information section corresponding to the at least one template information section. Based on the at least one generated content request, the at least one content primitive may further comprise at least one instruction, respectively corresponding to the at least one template information section, to be usable by the at least one learning model to generate at least one of the at least one generated information section according to the at least one template based on the at least one standardized template portion.

In an example embodiment, the at least one content portion may comprise at least one text portion corresponding to the at least one standardized template portion, and the method may further comprise converting, by the at least one computing system according to the at least one standardized data format, the at least one content portion to result in at least one standardized content portion. The applying of the at least one content portion to the at least one learning model may comprise applying the at least one standardized content portion to the at least one standardized template portion.

The at least one content portion may comprise at least one of: at least one image portion, at least one computer code portion, or at least one table portion. The at least one standardized content portion may comprise at least one of: at least one standardized image portion corresponding to the at least one image portion, at least one standardized computer code portion corresponding to the at least one computer code portion, or at least one standardized table portion corresponding to the at least one table portion.

The at least one standardized image portion may comprise at least one image portion indication indicative of the at least one image portion, wherein the at least one standardized computer code portion comprises at least one computer code portion indication indicative of the at least one computer code portion, and wherein the at least one standardized table portion comprises at least one table portion indication indicative of the at least one table portion. An image portion indication, a computer code portion indication, or a table portion indication may be referred to as a placeholder.

The at least one template may comprise an example document that comprises at least one of: at least one text portion and at least one non-text portion. The at least one generated content portion may be generated to correspond to the at least one template. In an example embodiment, the at least one generated content portion may be a standardized format version of the at least one template that has been updated with the at least one generated content portion.

In an example embodiment, the at least one content portion may be stored by at least one storage equipment corresponding to the at least one computing system. The at least one image portion indication may comprise at least one image address, associated with the at least one storage equipment, indicative of an image storage location of the at least one image portion, for example an address corresponding to the storage equipment indicative of where the at least one image portion is stored by the storage equipment. Similarly, the at least one computer code portion indication may comprise at least one computer code address, associated with the at least one storage equipment, indicative of at least one computer code storage location of at least one file comprising the at least one computer code portion, and the at least one table portion indication may comprise at least one table address, associated with the at least one storage equipment, indicative of at least one storage location of the at least one table portion.

In an example embodiment, the at least one template may comprise at least one text portion. The at least one template may comprise at least one table of contents indicative of the at least one text portion. The converting of the at least one template to result in the at least one standardized template portion may comprise parsing the at least one template according to the at least one table of contents to result in the at least one standardized template portion that comprises parsed content and generating, based on the parsed content, at least one generated template key-value pair, or data in another data format, corresponding to the at least one template. The at least one generated template key-value pair may be usable by the at least one learning model to generate the at least one generated content portion.

In an example embodiment, the at least one standardized data format comprises at least one key-value pair, or at least one other data type. The at least one key-value pair or other data type may comprise at least one JavaScript Object Notation key-value pair or other JavaScript Object Notation data type.

In an example embodiment, the method may further comprise generating, by the at least one computing system, a snapshot of the at least one generated content portion. The at least one generated content request may be a first generated content request. The at least one content portion may be at least one first content portion. The at least one generated content portion may be a first generated content portion. The at least one content primitive may be a first content primitive. The at least one content portion indication may be a first content portion indication. The at least one template indication may be a first template indication. The at least one template may be a first template. The at least one learning model may be a first learning model. The method may further comprise responsive to a second generated content request to generate at least one second generated content portion, generating, by the at least one computing system, a second content primitive comprising a second content portion indication indicative of at least one snapshot content portion, corresponding to the snapshot, to be used to generate the at least one second generated content portion and a second template indication indicative of a second template to be used to generate the at least one second generated content portion. Responsive to the second generated content request, the method may further comprise converting, by the at least one computing system according to the at least one standardized data format, the at least one snapshot content portion to result in a second standardized template portion. The method may further comprise applying, by the at least one computing system according to the second standardized template portion, at least one second content portion to a second learning model to result in the at least one second generated content portion.

In an example embodiment, at least one token maximum, or limit, may correspond to the at least one learning model. The at least one generated content portion may comprise multiple generated content portions. Each of the multiple generated content portions may respectively correspond to a generated content portion size that is based on the at least one token maximum and that is not based on any other of the multiple generated content portions. Thus, a generated content portion may be generated by the learning model to a full extent of a token maximum that the learning model is capable of using to generate output and another generated content portion may also be separately generated by the learning model to the full extent of the token maximum that the learning model is capable of using to generate output.

In another example embodiment, a computing system may comprise at least one processor that is configured to process executable instructions that, when executed by the at least one processor, may facilitate performance of operations that may comprise, responsive to at least one generated content request to generate generated content output comprising at least one generated content portion based on at least one content portion, generating at least one content primitive comprising at least one content portion indication indicative of the at least one content portion to be used to generate the at least one generated content portion and at least one template indication indicative of at least one template to be used to generate the at least one generated content portion. Responsive to the at least one generated content request, the operations may further comprise converting, according to at least one standardized data format, the at least one template to result in at least one standardized template. Responsive to the at least one generated content request, the operations may further comprise converting, according to at least one standardized data format, the at least one content portion to result in at least one standardized content portion. The operations may further comprise applying the at least one standardized content portion and the at least one standardized template to at least one learning model to result in the at least one generated content portion. The at least one template may comprise at least one template information section. The at least one generated content portion may comprise at least one generated information section corresponding to the at least one template information section. Based on the at least one generated content request, the at least one content primitive may further comprise at least one instruction, respectively corresponding to the at least one template information section, to be usable to facilitate generating, using the at least one learning model, each of the at least one generated information section according to the at least one template information section and based on the at least one standardized content portion.

In an example embodiment, the at least one instruction may comprise a first instruction indication indicative of a second instruction or at least one example indication indicative of at least one of at least one example of at least one style characteristic comprising at least one of: at least one grammar style, at least one image characteristic, at least one document layout characteristic, or at least one writing style.

In an example embodiment, based on the at least one content primitive, a writer agent may generate at least one prompt to be usable as at least one input to the at least one learning model.

In an example embodiment, the at least one standardized template and the at least one standardized content portion may be provided to the at least one learning model via at least one application programming interface. The at least one generated content portion may be generated according to the at least one standardized data format to result in at least one standardized generated content portion. The operations may further comprise converting the at least one standardized generated content portion to an original data format corresponding to the at least one template information section.

In yet another example embodiment, a non-transitory machine-readable medium may comprise executable instructions that, when executed by at least one processor of at least one computing system, may facilitate performance of operations that may comprise responsive to at least one generated content request to generate generated content output that may comprise at least one generated content portion based on at least one content portion, generating at least one content primitive comprising at least one content portion indication indicative of the at least one content portion to be used to generate the at least one generated content portion and at least one template indication indicative of at least one template to be used to generate the at least one generated content portion. Responsive to the at least one generated content request, the operations may further comprise converting, according to at least one standardized data format, the at least one template to result in at least one standardized template portion. Responsive to the at least one generated content request, the operations may further comprise converting, according to at least one standardized data format, the at least one content portion to result in at least one standardized content portion. The operations may further comprise applying the at least one standardized content portion, according to the at least one standardized template portion, to at least one learning model to result in at least one standardized generated content portion. The at least one template may comprise at least one template information section. The at least one generated content portion may comprise at least one generated information section corresponding to the at least one template information section. Based on the at least one generated content request, the at least one content primitive may further comprise at least one prompt, or at least one instruction, respectively corresponding to the at least one template information section, to be usable to facilitate generating, via usage of the at least one learning model, the at least one generated information section according to the at least one template information section based on the at least one content portion.

In an example embodiment, the at least one content portion may comprise at least one of: at least one image, at least one graphical representation, at least one table, at least one video, at least one slide presentation, at least one mathematical equation, or at least one interactive item. The at least one standardized content portion may comprise at least one placeholder indicative at least one of: the at least one image, the at least one graphical representation, the at least one table, the at least one video, the at least one slide presentation, the at least one mathematical equation, or the at least one interactive item. The at least one placeholder may not be applied to the at least one learning model. Thus, the at least one learning model may be configured to recognize the placeholder and avoid generating content based on the at least one placeholder.

In an example embodiment, the at least one generated content portion may be generated according to the at least one standardized data format. The operations may further comprise combining multiple of the at least one generated content portion according to the at least one standardized template portion to result in the generated content output.

According to yet another example, a method embodiment may comprise, responsive to at least one generated content request to generate at least one generated content portion, wherein the at least one generated content request comprises context information, and based on the context information, facilitating, by at least one computing system comprising at least one processor, generating at least one generated content outline comprising at least one generated content portion indication indicative of at least one generated content portion to be generated. The method may further comprise facilitating, by the at least one computing system according to the at least one generated content outline, applying context content to at least one learning model to result in the at least one generated content portion.

The at least one generated content outline, which may be a template or which may be generated from a template, may comprise a first generated content portion indicative of a first generated content portion to be generated and a second generated content portion indicative of a second generated content portion to be generated. The at least one generated content portion may comprise the first generated content portion and a second generated content portion, respectively corresponding to the first generated content portion to be generated and the second generated content portion to be generated. The at least one learning model may be applied to the context content to result in the second generated content portion after the first generated content portion has been generated.

In an example embodiment, the at least one generated content outline may be generated recursively. One section of the at least one generated content outline may be considered with respect to generating another section of the at least one generated content outline.

In an example embodiment, the at least one generated content outline may comprise at least one main level indication indicative of at least one generated main level section to be generated as at least one of the at least one generated content portion. The at least one generated content outline may comprise at least one sublevel indication indicative of at least one generated sublevel section to be generated as at least one of the at least one generated content portion. Each of the at least one main level indication may be generated recursively with respect to at least one other of the at least one main level indication. Each of the at least one sublevel indication may be generated recursively with respect to at least one other of the at least one sublevel indication.

In an example embodiment, the at least one generated main level section and the at least one generated sublevel section may each be generated according to a maximum token value corresponding to the at least one learning model.

In an example embodiment, based on the at least one generated content portion indication, the method may further comprise facilitating, by the at least one computing system, determining the context content to be applied to the at least one learning model to result in at least one determined context content portion. Based on the at least one generated content request, the at least one determined context content portion may be determined to respectively correspond to the at least one generated content portion indication.

In an example embodiment, the method may further comprise, further responsive to the at least one generated content request, facilitating, by the at least one computing system, combining the at least one generated content portion to result in at least one combined generated content portion.

In an example embodiment, the method may further comprise facilitating, by the at least one computing system, recursively editing at least one of the at least one generated content portion corresponding to the at least one combined generated content portion with respect at least one other of the at least one generated content portion corresponding to the at least one combined generated content portion, to result in a recursively edited at least one combined generated portion.

In an example embodiment the recursively editing may comprise reducing a size of at least one of the at least one generated content portion to result in at least one reduced size generated content portion and applying the at least one reduced size generated content portion and at least one other of the at least one generated content portion to the at least one learning model to result in at least one smoothed generated content portion. The at least one smoothed generated content portion may be included in the at least one combined generated portion and the at least one reduced size generated content portion may not be included in the at least one combined generated portion.

The at least one of the at least one generated content portion may comprise text. The reducing the size of the at least one of the at least one generated content portion may comprise deleting at least one sentence of the text.

In an example embodiment, the at least one generated content request may comprise at least one size limit applicable to the at least one generated content portion.

In another example embodiment to, a computing system may comprise at least one processor configured to process executable instructions that, when executed by the at least one processor, may facilitate performance of operations that may comprise, responsive to at least one generated content request to generate at least one generated content portion, wherein the at least one generated content request comprises context information, and based on the context information, instantiating a planner agent configured to recursively generate at least one generated content outline comprising at least one generated content portion indication indicative of at least one generated content portion to be generated. Responsive to the at least one generated content request, The operations may further comprise instantiating a writing agent configured to, according to the at least one generated content outline, apply context content to at least one language learning model to result in the at least one generated content portion. The writing agent may be further configured to generated the at least one generated content portion recursively.

In an example embodiment, the operations may further comprise instantiating an editor agent configured to recursively edit the at least one generated content portion.

In an example embodiment, the operations may further comprise instantiating a retrieval agent configured to retrieve, from storage equipment corresponding to the at least on computing system, the context content according to the at least one generated content outline to result in retrieved context content and to forward the retrieved context content to the writing agent according to the at least one generated content outline.

In yet another example embodiment, a non-transitory machine-readable medium may comprise executable instructions that, when executed by at least one processor of at least one computing system, may facilitate performance of operations that may comprise instantiating a supervisor agent configured to manage at least a planning agent, a writing agent, and a retrieval agent and receiving, by the supervisor agent, a document request, comprising context information, to generate a generated document that comprises at least one generated document portion. Responsive to the document request, the operations may further comprise causing the supervisor agent to cause the planning agent to recursively generate, based on the context information, a generated content outline comprising at least one document section portion indication indicative of at least one document section portion of the generated document to be generated. Responsive to the generated content outline being generated, the operations may further comprise causing the supervisor agent to cause the retrieval agent to retrieve context content corresponding to the at least one document section portion indication to result in retrieved context content. Responsive to the retrieved context content being retrieved, the operations may further comprise causing the supervisor agent to cause the writing agent to recursively apply the retrieved context content to at least one language learning model to generate the at least one generated document portion based on the retrieved context content. The operations may further comprise combining the at least one generated document portion to result in the generated document.

In an example embodiment, the at least one document section portion comprises at least one of: at least one chapter, at least one section, or at least one subsection.

In an example embodiment, the context information may comprise at least one size limit to be applied by the writing agent in generating at least one of: the at least one chapter, the at least one section, or the at least one subsection.

In an example embodiment, each of the at least one of the at least one chapter, the at least one section, or the at least one subsection maybe generated according to a full token size capability of the at least one language learning model.

### BRIEF DESCRIPTION OF THE DRAWINGS

FIG. 1 illustrates an example computing environment to use a learning model to generate requested content using according to a template.

FIG. 2 illustrates a computing environment to facilitate generating requested generated content according to a template.

FIG. 3 illustrates an example hierarchical template and context content applied thereto.

FIG. 4 illustrates example computing agents that facilitate recursively generating generated content.

FIG. 5A illustrates example context content reference information in an original form.

FIG. 5B illustrates example context content reference information in a standardized format.

FIG. 5C illustrates an example template in an original format.

FIG. 5D illustrates an example template in a standardized format.

FIG. 5E illustrates example standardized generated content.

FIG. 5F illustrates example generated content in an original format.

FIG. 6 illustrates a flow diagram of an example method to generate content according to a template.

FIG. 7 illustrates a block diagram of an example method.

FIG. 8 illustrates a block diagram of an example system.

FIG. 9 illustrates a block diagram of an example non-transitory machine-readable medium.

FIG. 10 illustrates a computer environment.

FIG. 11 illustrates an example template in a standardized format with placeholders.

FIG. 12 illustrates an example content primitive.

FIG. 13 illustrates a flow diagram of an example method embodiment to recursively generate content according to an outline.

### DETAILED DESCRIPTION OF THE DRAWINGS

As a preliminary matter, it will be readily understood by those persons skilled in the art that the present embodiments are susceptible of broad utility and application. Many methods, embodiments, and adaptations of the present application other than those herein described as well as many variations, modifications and equivalent arrangements, will be apparent from or reasonably suggested by the substance or scope of the various embodiments of the present application.

Accordingly, while the present application has been described herein in detail in relation to various embodiments, it is to be understood that this disclosure is illustrative of one or more concepts expressed by the various example embodiments and is made merely for the purposes of providing a full and enabling disclosure. The following disclosure is not intended nor is to be construed, to limit the present application or otherwise exclude any such other embodiments, adaptations, variations, modifications and equivalent arrangements, the present embodiments described herein being limited only by the claims appended hereto and the equivalents thereof.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

According to conventional techniques, a problem exists with creating extensive documents, for example reports 300 pages and greater in length that may contain rich content such as, for example, images, text, tables, or complex formatting. The increasing prevalence of generative artificial intelligence (“generative AI”) has simplified the creating of, and reduced the time to create, long documents. However, generative AI nevertheless has limitations due to token limits corresponding to learning models and due to computational intensity needed by the learning models. These limitations make it difficult to efficiently produce lengthy, well-structured documents. However, it is desirable to handle instructions to create a document, to process many content reference material document, or to use an existing document as a template for creating long form documents, for example technical whitepapers, technical articles, instruction manuals, user manuals, magazine articles, online articles, legal documents, and the like. Accordingly, embodiments disclosed herein may solve problems that may be imposed by token limits corresponding to learning modes and may solve problems of generated content not being succinct or not facilitating smooth reading. According to example embodiments disclosed herein, a document may be identified as being a candidate for a template. The template may be converted to a standardized format, for example, JavaScript Object Notation (“JSON”) comprising key-value pairs and/or other JSON data. According to example embodiments disclosed herein, documents to be used as to, or that may comprise, context content may be identified and converted to the standardized format. The template and the context content that have been converted to the standardized format may be applied to a learning model for generation of generated content according to at least one section of the template. In an example embodiment, a template section, or portion, may comprise a chapter, a section of a chapter, a subsection of a section, a sub-subsection of a subsection, and the like. After new, or updated, generated content has been generated in the ‘standardized format domain’ (e.g., inputs to a learning model may be JSON key-value pairs and generated content that is an output of a learning model may be JSON key-value pairs), a standardized-format generated-content/document may be converted from the standardized format to an original format that may correspond to the template or to at least one of the context content documents that may have been applied as at least one input to the learning model to result in the generated content. The generated content that is now in the original format may be presented to a user, via a user interface, that requested the generated content. Although JSON is used as an example of a standardized format for formatting a template or context content, it will be appreciated that example embodiments disclosed herein may convert template or context content documents to other standardized formats before application to a learning model.

According to at least one example embodiment disclosed herein, at least one application programming interface (“API”) may be used to provide a standardized-format template or at least one context content portion as at least one input to a learning model and at least one API may be used to provide output content, generated by a learning model, to a service that may convert the generated content from the standardized-format back to an original format. According to at least one example embodiment disclosed herein, to handle context content that may comprise items or objects other than text, at least one placeholder, indicative of the non-textual items or objects, may be included in a standardized-format to represent the non-textual content. The at least one placeholder may not be processed by a learning model and may be included ‘as-is’ in content that a learning model outputs in the standardized format. According to at least one example embodiment disclosed herein, when the standardize-format generated content is converted back to an original format a file, an item, or object, corresponding to the at least one placeholder, may be retrieved and inserted in the original-format version of the generated content. According to at least one example embodiment disclosed herein, each of at least one chapter, section, subsection, sub-subsection, and the like may be generated by a learning model one-at-a-time such that a learning model may generate each chapter, section, subsection, sub-subsection separately, thus facilitating use by the learning model of a full token limit, or full token ‘bandwidth’, available to, or corresponding to, the learning model.

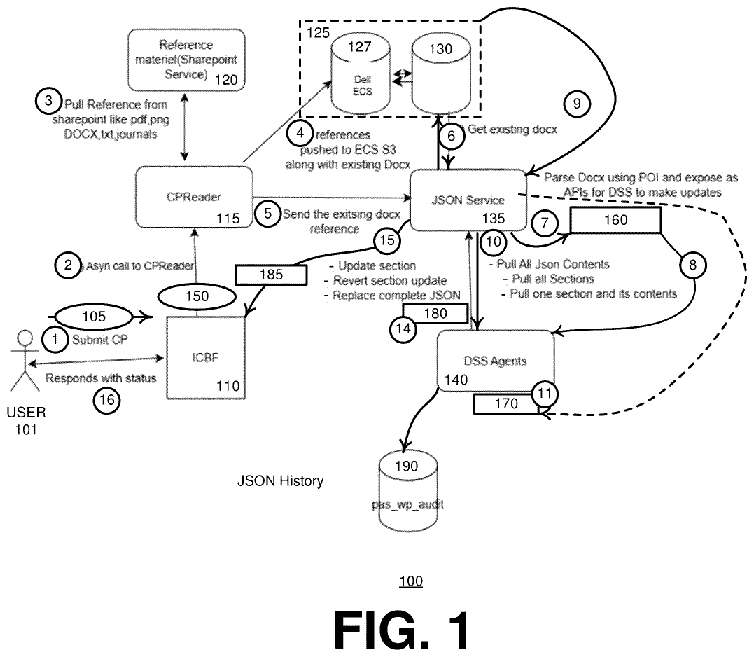

An existing long document, which may be selected to be a document template, or a ‘go-by’, may be parsed according to existing sections of the document or based on a table of contents corresponding to the document. For example, an instance of Apache POI project may be used to convert a . docx format file into a JSON structure (e.g., a standardized format) by parsing the file document based on a table of contents associated with the file document. The JSON structure may be preserved and exposed as an API for application by at least one learning model to facilitate generating requested generated content. JSON service 135, shown in FIG. 1, may use, or facilitate, at least one API. In an example embodiment, three APIs may be used to: 1) convert a retrieved document to a JSON structure, 2) to fetch a specific section, or 3) to get a specific subsection. Corresponding PUT APIs may facilitate updating a standardized template as at least one learning model generates content associated with a section or subsection corresponding to the template. The APIs may be deployed as AI microservices that can auto-scale according to the requested content to be generated.

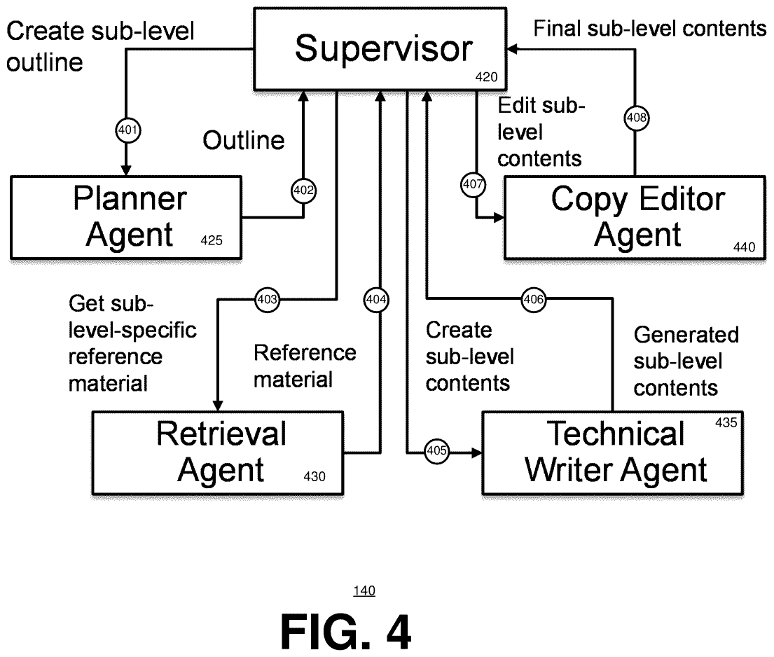

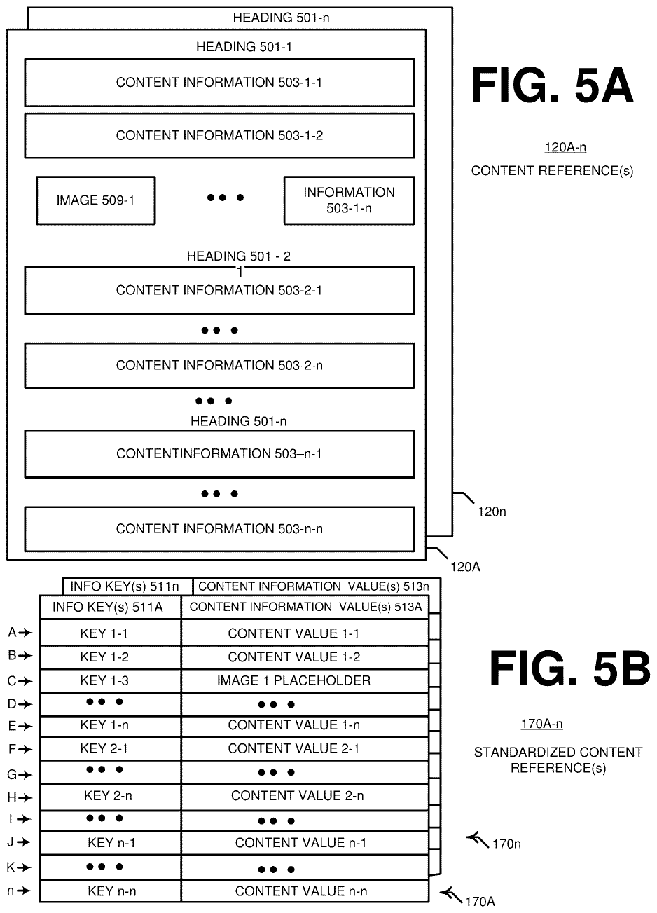

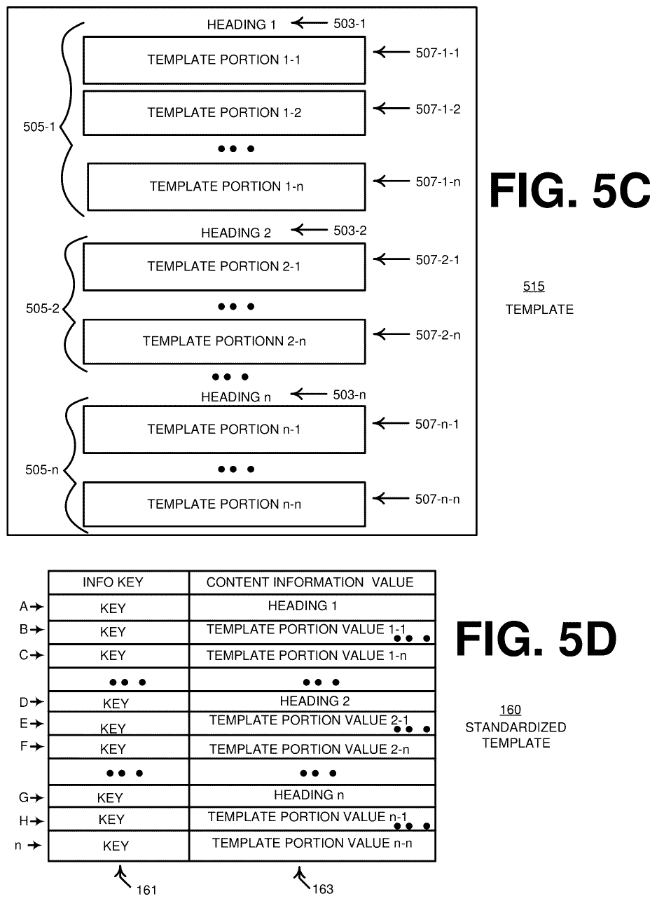

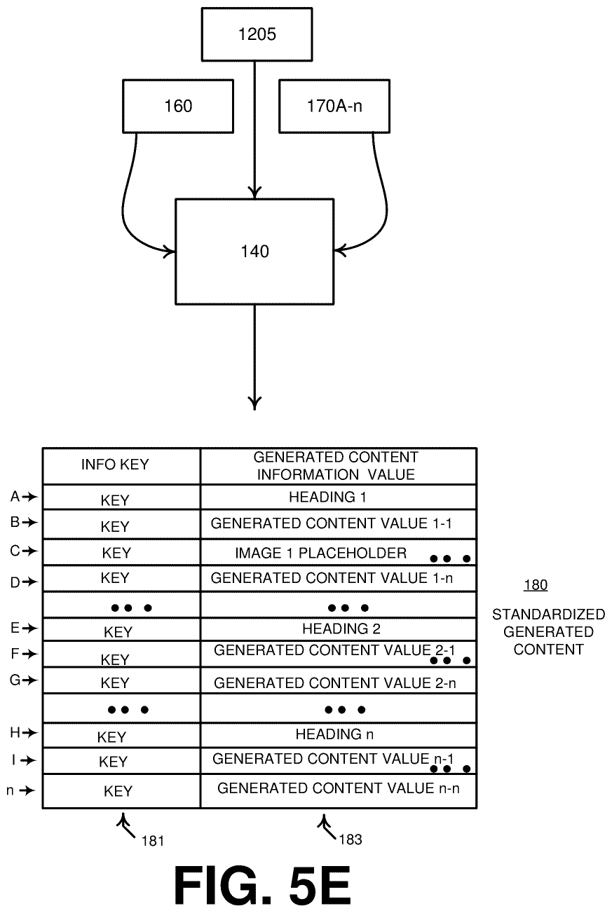

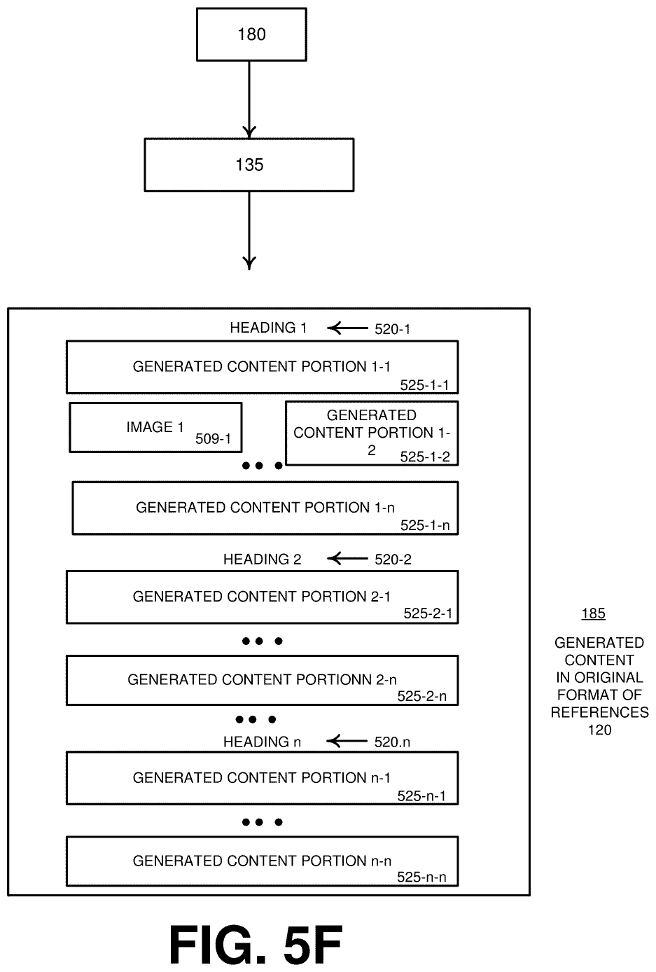

In an example embodiment, at least one agent 140 may receive instructions, which may be referred to, or that may be provided by, content primitives 150, from reader/service 115. A supervisor agent 420 (shown in FIG. 4), may scan the instructions and indicate each of at least one section of a template, or outline, along with reference material 120 (e.g., the indication of the reference material may comprise links, addresses, paths, file names, or other forms of identifying computer information or data) that may be stored by computing storage equipment 127. Retrieval agent 430 (shown in FIG. 4) may fetch content information from a vector store (e.g., storage equipment that comprise standardized JSON version of context content), and supervisor agent 420 may orchestrate providing of content primitive instructions/prompts to writer agent 435 (shown in FIG. 4). Writer agent 435 (shown in FIG. 4) may generate system prompts based on instructions and context indicated by a content primitive and the writer agent may call a learning model for generation of generated content based on the context information and prompts. After a section of generated content has been generated, supervisor agent 420 may call an API to facilitate updating a standardized version of the template with the generated content section/portion via a PUT API. A final updated standardized-format template (e.g., a JSON template 160 shown in FIG. 5D that has been updated to include generated content) having multiple sections that each have been updated, section-by-section, may be saved as a draft and directed/streamed to a micro front end for generating by a user interface for presentation to a user. A computing system may maintain an update history as each section of generated content is generated and a standardized template 160 is updated thereby.

In an example embodiment, a document to be used as a template 515 may be 300 pages long or more and may comprise different headers, sections, and styles. Each header, or each section, may comprise unique data and may comprise a unique combination the data and images, tables, code blocks, hyperlinks, and the like. A computing system may read a text file and generate a standardized-format version of the text file. If the template document, or a context data file, comprises an image, the image may be stored in a map with associated image height and width. Tables may be converted into hypertext markup language (“HTML”) versions to facilitate rendering the tables and storing the tables in a map. Code blocks (e.g., textual lines of computer code) may be read and stored in a map. Placeholders may replace the images, tables, code blocks, or other non-textual objects in standardized version(s) of the template or context data to facilitate the non-textual objects being retained in the standardized format versions of the template or context information. A learning model that may facilitate generating content according to the template or context information may be configured to disregard the placeholders during content generation. A standardized version of the template may be stored at computing storage equipment that may be part of or that may be communicatively coupled with the computing system.

APIs may be used to facilitate applying the template and context data in standardized format to at least one learning model agent. Generated content may be generated in the ‘standardized format domain’ (e.g., at least one learning model may generate content based on content retrieved from context content that has been converted into a standardized format (e.g., JASON key-value pairs)). Context information may be retrieved and applied to the template section-by-section.

Generated content may be generated section-by-section according to sections indicated by the template. At least one learning model agent may update a document, that may begin as the template, section-by-section as a learning model generates content according to each section indicated by the template and based on instructions and reference material (e.g., based on prompts and context content). Learning model agents may update the template based on the journal/instruction prompts shared via APIs. Using APIs, at least one agent may update an individual section, or a complete document. At least one agent may insert images or other non-textual content based on the instructions/prompts. Example update functionality that may be facilitated by at least one API may comprise: update section; update complete document with generated content, revert an updated section/portion to a previous version; or revert an updated document to a previous version, for example an original document that may have been used as a basis for generating a template.

In an example embodiment, generation/update history may be maintained with respect to at least one update that learning model agents may have made to facilitate future functionality, such as reverting to previously updated content or a base document. Such reverting may facilitate using an original document, that has been used to generate generated content, as a basis for a template for a different session of generating generated content.

In an example embodiment, an original format associated with a document that is used as the basis for a template may be preserved to facilitate consistency with respect to generated content and an original document format. APIs that may have been exposed to learning model agents may be used to facilitate rendering generated content to result in generated content being rendered via a user interface that is in a format that is consistent with an original document. Rendering of mapped images/tables/code blocks may be facilitated by placeholders.

Thus, embodiments disclosed herein may facilitate creating and using a structured template framework for decomposing and generating long-form content. According to techniques disclosed herein, a document format, including images, text, tables, downloadable links, etc., may be preserved without a learning model being bogged down with the actual images, text, tables, downloadable links, etc. being presented as input to the learning model. According to techniques disclosed herein, long documents with multiple sections may be generated, with each section being generated separately from generating the other section to facilitate a learning model using a full token limit, or token ‘bandwidth’, available to the model. Benefits of orchestrating and generating long document content according to example embodiments disclosed herein may comprise reduced time to generate a document, reduced overhead and latency corresponding to processing data, and may result in many man hours being saved in generating content/documents.

An organization may have a style that the organization desires to be applied to generated documents. According to embodiments disclosed herein, a learning model may be provided with organization characteristic information corresponding to an organization's ‘vision’, tone’, or brand guidelines as context to facilitate a generated document being consistent with respect to the organization characteristic information. The use of a template by embodiments disclosed herein may facilitate generating content according to predefined sections, such as, for example, an introduction section, a vision section, or a specification section, and the like. Context to be used as input to a learning mode and that is derived from source materials/content, which may be selected by a user or which may be selected by a learning mode, may facilitate generating content corresponding to sections indicated by a template based on, for example, an organization's product specifications, vision, and content.

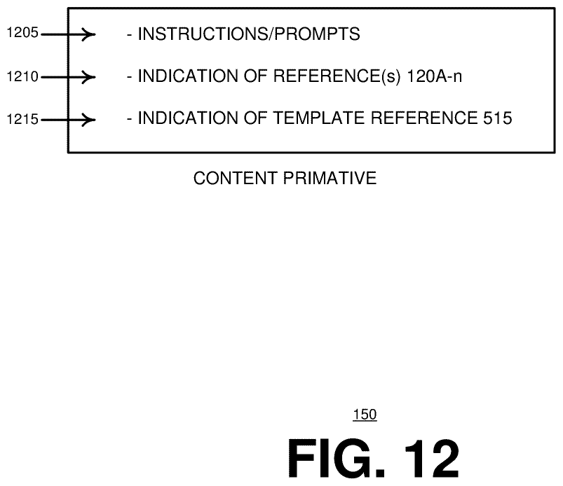

Continuing with description of FIG. 1, the figure illustrates an example computing environment 100 illustrative of at least one computing system, and equipment and components corresponding thereto, usable to generate generated content using information or data stored by containerized object storage system 125. Generated content may be generated in response to at least one generated content request 105, which may be received from a user 101 at act 1. Containerized object storage system 125 may use container technology within a container orchestration system that may facilitate providing application processes as services, or micro services. A request to generate content may be automatically generated or may be received from a user via a user interface communicatively coupled with computing system 110, which may be referred to as an intelligent content briefing framework system (“ICBF”). Request 105 may comprise information usable to create, at act 2, content primitive 150, which may be received by content primitive reader 115. Based on at least one content indication 1210 (shown in FIG. 12) indicated in content primitive 150 that is indicative of at least one reference context content portion 120, which may be referred to as at least one content portion, the at least one context content portion 120 may be retrieved from storage equipment or a storage instance, which may comprise, or which may facilitate, storage by cloud-based computing storage equipment. A content portion 120 may comprise a text file, a portion of a text file, an image or an image file, a video or a video file, a table, a spreadsheet file, and the like. Content primitive 150 may comprise at least one content portion indication 1210 that is indicative of at least one content portion to be used to generate the requested at least one generated content portion. For example, content primitive 150 may comprise at least one indication 1210 that corresponds to, or that is indicative of, at least one content portion 120 (e.g., the content portion indication may come a file name or a path corresponding to a content portion 120). Content primitive 150 may comprise at least one template indication 1215 (shown in FIG. 12) indicative of at least one template 515 to be used to generate the at least one generated content portion. The at least one template indication may comprise an address, a file name, a path corresponding to a file, or a portion thereof, or other form of indicating digital data, to be used as an exemplary template for generation of the requested generated content that may be requested via request 105. In an example embodiment, the at least one template indication 1215 may be indicative of a text file that is also one of the at least one content portion 120. In another example embodiment, the at least one template indication may be indicative of a different file than one of the at least one content portion 120. Content primitive 150 may comprise instructions 1205 (shown in FIG. 12) regarding the generated content to be generated. For example, content primitive 150 may comprise at least one prompt (e.g., instruction 1205 as shown in FIG. 12 may comprise at least one prompt to facilitate a learning model generating generated content) to be used as an input to at least one learning model that may be used in the generation of the generated content to be generated.

At act 4, content primitive reader 115 may facilitate copying, replicating, pushing, or otherwise making at least one content portion 120 being stored by storage system 125, which may comprise storage equipment 127 or database management system/service 130 (e.g., a Postgres management system), available to JSON service 135. At act 5, content primitive reader 115 may indicate to JSON service 135 at least one template portion 515 indicated by indication 1215 corresponding to content primitive 150. Based on the at least one template portion indicated by content primitive 150, JSON service 130 may retrieve, or otherwise obtain, the at least one template portion indicated by content primitive 150. At act 6, JSON service 135 may obtain, via storage service 130, the at least one template portion indicated by content primitive 150. At act 7, JSON service 130 may convert the at least one template portion 515 retrieved or obtained at act 6 into a standardized template portion 160. For example, as shown in FIGS. 5A and 5B, standardized template portion 160 may comprise key-value pairs 161/163 corresponding to, or indicative of, the at least one template portion 515. Key-value pairs 161/163 may be used by a learning model to generate the generated content to be generated as requested by request 105. At act 8, shown in FIG. 1, standardized template portion 160 and standardized generated content 170 may be provided to at least one content generating agent 140 for use thereby in generating generated content based on the standardized content as shown in FIG. 5E to result in generated content 180.

At act 9, the at least one content portion 120, which may be stored by storage system 125, may be provided to service 135. At act 10, service 135 may convert the at least one content portion 120 into at least one standardized content portion 170, which may be provided to at least one agent 140 to facilitate generating thereby the generated content requested at act 1. At act 11, at least one of the at least one generating agent 140 may generate the requested generated content, which may be output by at least one of the at least one generating agent as standardized generated content 180 (e.g., generated content 180 may be generated according to a JSON format/JSON key-value pairs). At act 14, the at least one generating agent 140 may provide standardized generated content 180 to JSON service for conversion thereby at act 15 into an original format corresponding to the at least one template portion or the at least one content portion. For example, if content portion(s) 120 or template portion(s) that are converted into standardized template portion(s) 160 is/are stored by storage system 125 in a text format, such as for example, a .docx format, JSON service 135 may convert generated content portion(s) 180 into .docx-format portions 185. Thus, at least one learning model, facilitated by at least one agent 140, may generate content as JSON key-value pairs and the JSON-format template may become a working template that may be updated with standardized format content as the standardized format content is generated by the at least one agent. After requested generated content has been generated (e.g., after the at least one standardized template portion has been updated to include standardized generated content in the standardized format, to result in at least one updated standardized template portion), the at least one updated standardized template portion may be converted, by JSON service 135, into an original format that corresponds to the at least one template portion indicated by content primitive 150 before the at least one template portion was converted, by the JSON service, into the at least one standardized template portion. At act 15, JSON service may insert image, video, code block portions, or other non-text portions, that may have been included in content 120 used for generation of generated content 170 and that may have been indicated in the standardized version (e.g., JSON key-value pairs of the content 120) as placeholders (e.g., a file name, an address, a pate, and the like) corresponding to storage of the non-text content by storage system 125, into the generated content 185 after converting the generated content 170 into an original format corresponding to the at least one template portion before being converted, at act 5, into the at least one standardized template portion. At least one standardized template portion 160 version, as updated at act 11 with standardized generated content to result in at least one updated standardized generated content, may be stored to storage service 190 as at least one snapshot to facilitate reverting to the at least one standardized template portion version.

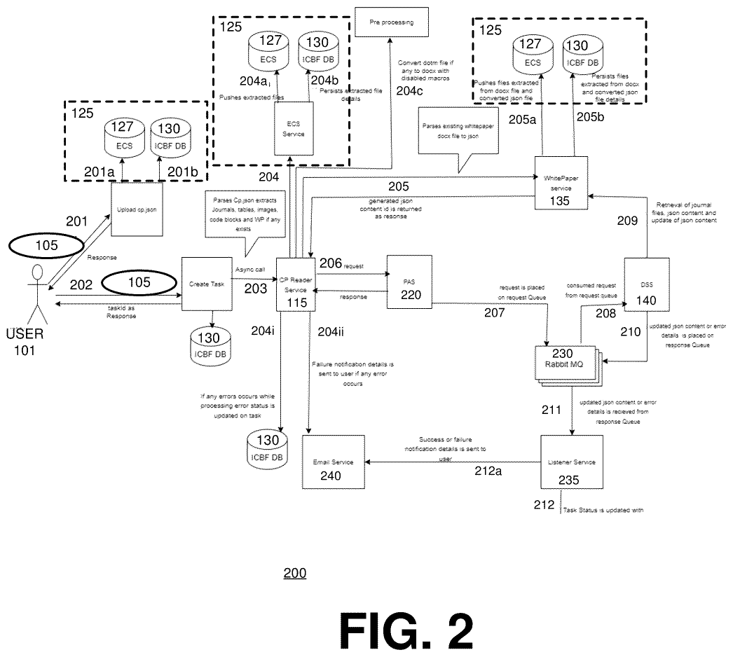

Turning now to FIG. 2, the figure illustrates a computing environment 200 to facilitate generating requested generated content according to a template. User 101 may generate, enter, send, or otherwise instruct a computing system corresponding to components illustrated in FIG. 2 to generate content. Request 105 may comprise an indication of files or other objects to be used to generate the generated content. For example, request 105 may indicate at least one text file corresponding to a text document and at least one object, for example an image, a video, a table, computer code that may be in a text format but that is not to be used to generate the generated content, or other non-textual information. Request 105 may comprise instructions, or prompts, to be used in generating the requested generated content. Responsive to request 105, at act 201 data files or other objects corresponding to information indicated in the request to be used to generate the generated content may be uploaded to computing storage system 125. At act 201a, files corresponding to the information to be used to generate the generated content may be uploaded to storage equipment 127 and metadata or other information corresponding to the files or objects uploaded to the storage equipment may be stored to or made available to database 130 at act 201b. At act 202, responsive to request 105, task information corresponding to request 105 may be created and indicated to database 130 via a content primitive 150 as described in reference to FIG. 1. The content primitive may be provided at act 203 to content primitive reader 115. At act 204, files or other objects stored to storage equipment 127, and metadata corresponding thereto that may be stored by database 130, may be parsed. At act 205, service 135, which may comprise a JSON service as described in reference to FIG. 1, may convert files or objects retrieved from storage equipment 127 into a standardized format, for example JSON key-value pairs. Standardized versions of files or objects converted by service 135 may be stored to storage equipment 127 at act 205a and details or data (e.g., metadata) corresponding to the standardized versions of the files or objects may be stored to database 130 at act 205b. At act 206, permission authorization service 220 may permit generating of content requested by request 105. At act 207, upon permission being granted to perform generating of content as requested by request 105. The request may be sent to, stored by, buffered by or otherwise provided to message broker 230, which may comprise, for example, a Rabbit MQ message broker.

At act 208, queued request 105 may be provided from message broker 230 to at least one learning model agent 140. The at least one learning model agent, which may comprise a retrieval agent, may retrieve at act 209 a template and content in the standardized form from service 135, which may, responsive to a retrieval request from the retrieval agent, retrieve the standardized-format template and content and provide the content to the at least one agent 140, which may comprise a writer agent. At act 210, the writer agent may generate content section-by-section according to the standardized template and provide the generated content, which may be referred to as updated generated content insofar as a template section that may start out as blank is updated with generated content. Generated content may be provided to message broker 230 which may facilitate returning generated content to at least one of the at least one agent 140 for inclusion of the generated content into the template and for editing. At act 211, message broker 230 may indicate to listener service 235 success of the requested generated content being generated or may indicate to the listener service that an error occurred in generating the requested generated content. At act 212, listener service 235 may update content primitive 150 to be indicative of success or failure with respect to generating the requested generated content. At act 212a, listener service 235 may indicate to e-mail service 240 success or failure with respect to generating the requested generated content. Returning to description of act 204, at act 204i, a processing error corresponding to processing of request 105 or content primitive 150 may be updated to database 130 and at act 204ii the error may be indicated to e-mail service 240 for indication thereby to user 101 of the error

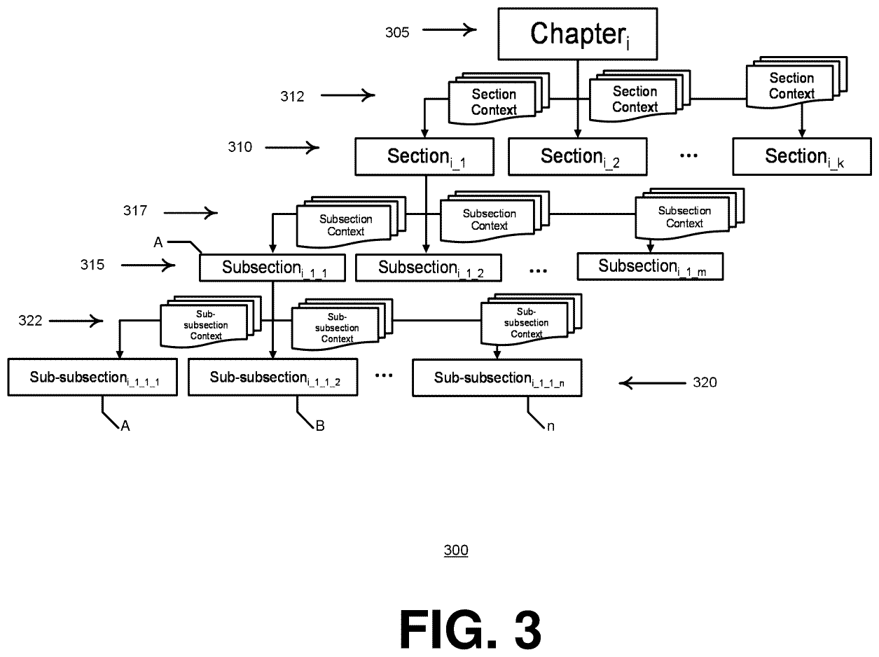

FIG. 3 illustrates an example hierarchy 300 of at least one example template section, or template portion, that may correspond to example template 515 shown in FIG. 5C, and example context content that may be used to generate generated content to correspond to the at least one example template portion. The at least one template/outline portion may comprise at least one chapter section/portion 305, at least one section portion 310, at least one subsection portion 315, at least one sub-subsection portion 320, and so on. At least one context content portion may comprise at least one section context content portion 312, at least one subsection context content portion 317, at least one sub-subsection context content portion 322, and so on, respectively corresponding to the at least one section portion 310, the at least one subsection portion 315, the at least one sub-subsection portion 320, and so on. Context content may comprise content used by a learning model to generate generated content that corresponds to at least one template portion. Context content may be referred to herein simply as content and generated content may refer content that is generated by a learning model based on context content. Generated content corresponding to one or more sections/portions, for example sections 305, 310, 315, or 320 may be performed recursively, such that a section, or subsection thereof, is generated using context content corresponding to the section, or respective subsection, and a previous, or adjacent, section or subsection, or a subsequent, or adjacent, section or subsection, respectively corresponding to the section, or subsection thereof.

By generating content recursively, repetition of information generated with respect to more than one section or subsection may be avoided. However, several problems may exist with respect to recursively generating content. For example, to generate a long-form document, an amount of context that needs to be provided as prompt/input information to a learning mode may be very large such that the context information may exceed an input context limit corresponding to the learning model. An input context limit corresponding to a learning model may be based on a token limit corresponding to the learning model. An input context limit corresponding to a learning model may be based on a total token limit corresponding to the learning model. An output size limit corresponding to a learning model may be based on a total token limit corresponding to the learning model. Thus, regardless of a context window size corresponding to a learning model, a size of an output of the learning model may be based on fewer than the total token limit (e.g., an output size of the learning model may be based on a number of completion tokens corresponding to the learning model that may be fewer than the total number of tokens that correspond to the learning model). For example, a learning model may correspond to a context size of 128,000 tokens, but a number of completion tokens corresponding to the learning model may be capped at 4,000 tokens. Thus, the learning model may be limited to generating output that corresponds to only 4,000 tokens even though a total number of tokens corresponding to the learning model may be 128,000 tokens.

Another problem that may exist with respect to generating content by a learning mode may comprise what is sometimes referred to as ‘lost-in-the-middle effect’, wherein the ‘attention’ or ‘focus’ a learning model that may be designed to handle large context prompts may diminish for information located in the middle of a prompt. The lost-in-the-middle effect can lead to suboptimal performance in tasks wherein a model is to process or generate content based on relevant information that is not placed at the beginning or end of an input prompt. With respect to recursively generating content, a problem sometimes occurs wherein infinite recursive calls are performed and wherein parallel calls do not result in generation of the same content.

To overcome problems that may exist with respect to generating of content, computing agent embodiments illustrated in FIG. 4 may facilitate recursively generating generated content 180 shown in FIG. 1. FIG. 4 illustrates example computing agents that may correspond to at least one agent 140 shown in FIG. 1. Planner agent 425 may facilitate planning an overall outline of the document, which planning may be based on a template. Planner agent 425 may decompose a document that is selected to be the basis of a template into chapters, sections, and subsections. The decomposed template outline structure may be stored converted into a standardized format, such as, for example, a JSON format or a comma separated values (“CSV”) format. In decomposing a document that has been selected to be a template, planner agent 425 may, at act 402, be instructed by supervisor agent 420, to plan how deep each chapter should be (e.g., the planner agent may determine how to break down and organize a template with respect to chapters, sections, subsections, sub-subsections, etc.). Decomposing a document selected to be a template may comprise determining, or receiving as an instruction, a maximum depth to be applied to a generated content document or determining a limit on a number of characters each chapter or section may include. Planning of each outline section may be performed by planner agent 425 recursively.

Each chapter, section, or subsection, and so on of a document may comprise generated content generated by writer agent 435, which may receive relevant context, reference materials, and user-specific instructions. Relevant context may be retrieved at act 403 by retrieval agent 430, which may be configured to obtain content corresponding to a specific level, sub-level, sub-sublevel, and so on, of a document template. Retrieved content may be provided to supervisor agent 420, or at least indicated thereto, at act 404. At act 405, supervisor agent 420 or writer agent 435 may assign tasks to specialized sub-agents, each of which may participate in generating generated content. At act 408, sub-agents may return respective output content to a central service, for example writer agent 435 or supervisor agent 420, that may manage content references and that may continuously build/assemble a complete document, as content to become part of sections corresponding thereto are generated. At act 407, generated content corresponding to a complete document may be analyzed or edited in stages by copy editor agent 440 for smooth flow and to facilitate the document being cohesive, well-formatted, and efficiently generated. Copy editor 440 may also perform recursive analysis of each chapter, section, subsection, etc. using context content or generated content corresponding to a previous or a subsequent chapter, section, subsection, etc.

An example prompt to be provided to a planner agent 425 may comprise: “Plan the contents of a long-form document based on a provided description of the document and important themes it should include. Generate a list of chapters for the document and decompose each chapter into sub-levels like sections, subsections, etc. A retrieval agent can retrieve reference source documents with information usable to generate the contents of each chapter and its sub-levels. The output should be in an outline format containing a high-level description of each chapter, as well as the sub-levels of the chapter. The sub-level descriptions should include the relevant context that should be retrieved using the Retrieval agent. An optional limit may be provided with respect to a depth of each sub-level, or a word limit for each chapter, which may be applicable to each sub-level and may be included the word limit in the outline description.”

An example prompt to be provided to writer agent 435 may comprise: “Write the contents of a section of a document. An outline of a previous section and a subsequent section will be provided as context. Relevant reference material obtained from a retrieval agent will be provided. Specific instructions and an outline for a section to be written will be provided. Generated content should not overlap with content of neighboring, or adjacent, sections. Optionally, generated content must not exceed a certain word limit if provided.” Information included in a prompt may be included in, or indicated by, a content primitive 150.

With respect to example embodiments illustrated by FIG. 3, a first step may be to focus on generating a single chapter at a time. Context content usable to generate a chapter, including the outline and high-level description of each of its sub-levels and additional reference material, may be provided to writer agent 435 by retrieval agent 430. A chapter may contain a hierarchy of sections (e.g., sections, subsections, sub-subsections, and so on). Contents of each chapter may be created recursively by providing a sub-level outline and relevant context corresponding to each sub-level, including previous and next, or subsequent, sub-level outlines, to a learning model for generation of generated content. Generated content may be aggregated into a higher level of an outline until the generation of generated content corresponding to a chapter has been completed. Providing a previous sublevel outline and a subsequent sublevel outline to a learning model when generating generated content corresponding to a sub-level may facilitate minimizing overlap of generated content subject matter from sublevel to sublevel. Thus, recursively generating content, or a template heading, according to embodiments disclosed herein may avoid generated content converging to input that may be used by a learning model to generate the generated content. (Generated content in some example embodiments may comprise subject matter corresponding to headings of a template or outline that has been recursively generated.)

It will be appreciated that recursively generating content by a learning model is not the same as the learning model being recursively trained. Being recursively trained may refer to a model being trained using training data that may have been generated by another model or by the same model, which may result in propagation of errors and reduced usefulness of a recursively trained model. Recursive generating of content, as described herein, refers not to training of a model but to a model generating content corresponding to one section, or portion, of generated output corresponding to a project, task, or other instance, based on another section, or portion that the same model (with the same training) has generated with respect to the same project, task, or other instance. A benefit of recursively generating content as described herein may be that generated content corresponding to one section, or portion, of output is not repeated by, and is not the same as, content generated with respect to a different section, or portion, of output. Thus, instead of errors being propagated, as may occur when recursively training a model based on generated content, recursively generating content, as described herein, may result in a reduction of the same content being generated in different chapters, sections, subsection, sub-subsection, or other portions of generated content.

Continuing with description of FIG. 4, at least one agent 140 is shown that may collaborate to produce a final version of long-form content. Supervisor agent 425 may coordinate activity between the at least one agent 140. Supervisor agent 420 may iterate over at least one chapter indicated by a template and may make recursive calls for generation of content corresponding to each of at least one sub-level by writer agent 435. Subsequently, recursive calls may be made to editor agent 440 to edit content corresponding to each of the at least one sub-level. After content corresponding to each of at least one the chapters has been generated, the content may be passed to editor agent 440 to edit the content with respect to other sections to increase a likelihood that generated content flows smoothly from one section to the next and to enhance overall quality of an output document that contains edited generated content that may be edited by agent 440. Editor agent 440 may edit content of a section recursively with respect to at least one other section. For example, with respect to each of at least one sub-level of a chapter (e.g., with respect to at least one section, at least one subsection, at least one sub-subsection, etc.), content corresponding to a previous section of the sublevel, or a different sublevel, or corresponding to a next section of the sub-level, or a different sublevel, may be provided as context to editor agent 440. According, content corresponding to a sub-level, or a section thereof, may be evaluated in isolation and then may be evaluated in relation to content of a previous or next sub-level. Accordingly, recursively editing generated content section/portion-by-section/portion, even though each section/portion of a sub-level may be generated disparately or independently, may increase cohesiveness and overall flow of a final version of generated content.

Supervisor agent 420 may call planner agent 425 to generate a high-level outline of a document to be generated based on, for example, prompt information that may result from input information provided by a user. A user may provide an optional page-limit or word-limit for an entire document that may be used by planner agent 425 as a basis for a token limit to be applied to at least one outline item. The user can also provide a maximum depth value to be applicable to determination of at least one sub-level corresponding to a document to be generated. Planner agent 425 may generate a high-level outline/template with an optional word/token limit corresponding to each outline/template item. For each at least one outline/template item, planner agent 425 may recursively generate at least one sub-level outline. For each at least one sub-level outline item, planner agent 425 may implement a stop condition corresponding to recursion. For example, planner agent 425 may determine whether a token limit corresponding to a sub-level fits within a context length and completions limit that a learning model corresponding to writer agent 435 can accommodate in generating content corresponding to the sub-level. In another example, planner agent 425 may determine whether a maximum depth that may have been specified by a user has been reached (e.g., if a number of sublevels has been specified to be two, the planner agent may stop generating sublevel headings corresponding to a section after headings corresponding to two sublevel have been generated). If the stop conditions have not been met, planner agent may continue to recursively create outline/template items corresponding to a next sub-level in an outline hierarchy.

Otherwise, if at least one stop condition criterion has been reached, or satisfied, with respect to a sub-level item, planner agent 425 may provide a sub-level outline to supervisor agent 420, which may, at act 403, in response to receiving the sub-level outline, call retrieval agent 430 to retrieve relevant context resource information (e.g., information corresponding to references 120 shown in FIG. 1) corresponding to the sub-level outline item with respect to which the stop condition has been satisfied. Retrieval agent 430 may provide a retrieval result (e.g., retrieved context content information that corresponds to the sub-level item) to supervisor agent 420 at act 404. Supervisor agent 420 may direct the retrieved context content corresponding to the sub-level outline item to writer agent 435 to generate generated content corresponding to the sub-level item.

After planner agent 425 has completed planning sub-level outlines and generated content, corresponding to each sub-level, has been built up by delegating to supervisor agent 420 the calling of retrieval agent 430 and writer agent 435, the supervisor agent may call editor agent 440 at act 407. For each outline item, editor agent 440 may recursively evaluate and improve the quality of generated content corresponding to the sub-level. Stop conditions may be applicable to editor agent 440 with respect to halting recursion. To facilitate evaluating generated content of a sub-level and rewriting of contents thereof to ensure continuity and smooth language flow, editor agent 440 may determine to halt recursion if a token count corresponding to generated content corresponding to the sub-level plus token counts corresponding to content associated with a previous sublevel and a next sub-level is greater than a context length token limit or completion token limit corresponding to a learning model. In response to determining that a token limit criterion may have been violated, editor agent 440 may delete one or more sentences from generated content being evaluated for purposes of the editor agent evaluating the generated content for continuity and smooth flow, but the editor agent may not actually delete the sentences from a final version of the sublevel that has been generated for output to, at act 408, and supervisor agent 420.

Accordingly, using example embodiments disclosed herein, planner agent 425 may produce an outline document comprising outline items, each of which may be used to organize generation of content corresponding to sublevels associated with the outline item. Recursive generating/writing of separate sublevel section/portions may be controlled by arguments indicative of parallel processing of a document (e.g., supervisor agent 420 may delegate writing of different sections to different technical writer agents 435, which each could be a different thread/instance that may be using the same learning model to generate content). Copy editor agent 440 may facilitate smoothing overall flow of content generated by writer agent 435. Thus, example embodiments disclosed herein may advantageously provide for simplified generation of long-form documents using AI agents.

To avoid, or to minimize the occurrence of, a situation wherein control of generating content by an agent becomes uncontrolled with respect to information indicated by a prompt or other input information, certain constraints may be indicted in a prompt to a learning model that may limit a depth of content generated which may be based on a recursive depth tracking and limitation. For example, with respect to recursively breaking down a chapter into sections, sub-sections, . . . , a prompt may comprise an indication of a depth at which a learning model is to stop recursion (e.g., writer agent 435 may be indicated to avoid generating content at a farther depth than a user specifies in request 105).

In an example embodiment, a maximum depth constraint may correspond to an outline level that is four levels deep (e.g., a chapter having at least one section, at least one subsection, and at least one sub-subsection). In an example embodiment, a maximum depth may correspond to a limit on a number of subsection and section may comprise. In an embodiment, a minimum or maximum length of each lower-level section may be specified. For example, the smallest sub-section may be specified to contain a minimum length of 200 characters. Accordingly, constraints that may be placed in a prompt may facilitate a learning model not being able to make unbounded decisions. In an example embodiment, a termination criterion may be specified in a prompt. For example, when generation of content reaches an indicated number of iterations, or when a section has been completed according to a specified maximum depth, writer agent 435, or copy editor agent 440, may halt further generation of generated content. Supervisor agent 420 may manage or control a next recursion by evaluating a size, a relevance, a structure, and sections corresponding to generated content. Because a template may be used to guide overall recursive generation of content corresponding to sections, a learning model may be constrained by parameters that may be specified in a prompt corresponding to the template and thus danger of a learning mode making unbounded decisions is minimized.

FIG. 5C illustrates example template 515 and FIG. 5D illustrates standardized template 160 corresponding to template 515. Template 515 may comprise at least one section 505 having a heading 503. Each section 505 may comprise at least one subsection 507, each of which may in turn comprise sub-subsections, and so on. Each section 505, each subsection 507, and each further sub-subsection may be referred to as an information section. In an example embodiment, template 515 may start as a text document with at least one heading 503 corresponding to each of at least one section 505, subsection 507, or each sub-subsection, and so on. Each of section 505, subsection 507, or sub-section thereof may be referred to as a template portion. A text document to be used as a template may be selected, either by user 101 or by the computing system, to be a template, or a ‘go-by,’ for generating new content, and actual content (e.g., textual information, graphical information, image information, and the like) may be removed such that template 515 is a text document comprising headings in textual format corresponding to and indicative of at least one section 505, at least one subsection 507, or at least one sub-subsection. Template 515 may comprise textual placeholders that may be indicative of images or other non-textual content to be included in a generated document. The placeholders may refer to at least one storage location, for example at least one address indicative of at least one storage location associated with the non-textual content. Indicating non-textual content with textual placeholders that are indicative of the non-textual content may facilitate JSON service 135 accommodating converting of the placeholders into JSON key value pairs with respect to which a learning model may not perform content generation.

Turning now to FIG. 5A, the figure illustrates example context content 120, for example at least one text document. As shown in the figure, reference 120A may comprise heading 501-1, and context content information 503-1-1, context content information 503-1-2 and context content information 503-1-n. Information corresponding to heading 501-1 may also comprise image 509-1. Reference 120A may comprise heading 501-2 and corresponding context content information 503-2-1 and context content information 503-2-n. Reference 120A may comprise heading 501-nand corresponding context content information 503-n-1 and context content information 503-n-n. Multiple content references 120A-120n may be specified in a prompt, or in a content primitive 150, to be usable by a learning model to generate content. It will be appreciated that an example context content reference 120 may be selected to be used to generate template 515.

As shown in FIG. 5B, a standardized format representation 170 corresponding to example content 120 may comprise key value pairs. For example, keys 511 A-A-511A-n May be generated to correspond to information values 513A-A-513A-n, which may correspond to multiple content information portions 503 shown in FIG. 5A. Image 509-1 shown in FIG. 5A is represented as a placeholder by value 513A-C shown in FIG. 5B. Thus, if for example, a standardized format corresponding to a representation 170A is JSON key-value pairs, a learning model writer agent that may be presented with representation 170A may disregard information in cell 513A-C when generating content based on information contained in cells 513A-A-513A-B and cells 513A-D-513A-n. As shown in FIG. 5E, a learning model may generate standardized generating content 180 comprising keys 181A-181n and respectively corresponding information values 183A-183m. Standardized template 160 and standardized context content information 170A-170n, along with prompt information/instruction 1205 contained in a content primitive 150 may be provided to at least one agent 140 which may generate standardized generated content 180. It will be appreciated that a placeholder corresponding to image 509-1, shown in FIG. 5A, is represented in cell 183C as shown in FIG. 5E.

As shown in FIG. 5F, standardized content 180 may be provided, by at least one agent 140 via an API, to service 135, which may convert generated content information represented by standardized generated content 180 into original-format generated content 185, wherein the original format may correspond to a format, for example a .docx format, corresponding to a format associated with a context content reference 120. Original-format generated content 185 may comprise generated content portions 520 that are rendered in an original format that may corresponding to format associated with a reference 120. Portions 520 may be based on information values in column 183 of standardized generated content 180 shown in FIG. 5E. Based on placeholder 183C, service 135 may facilitate retrieving Image 1 509-1 from storge by storage equipment and may facilitate placing Image 1 into portion 509-1 shown in FIG. 5F.

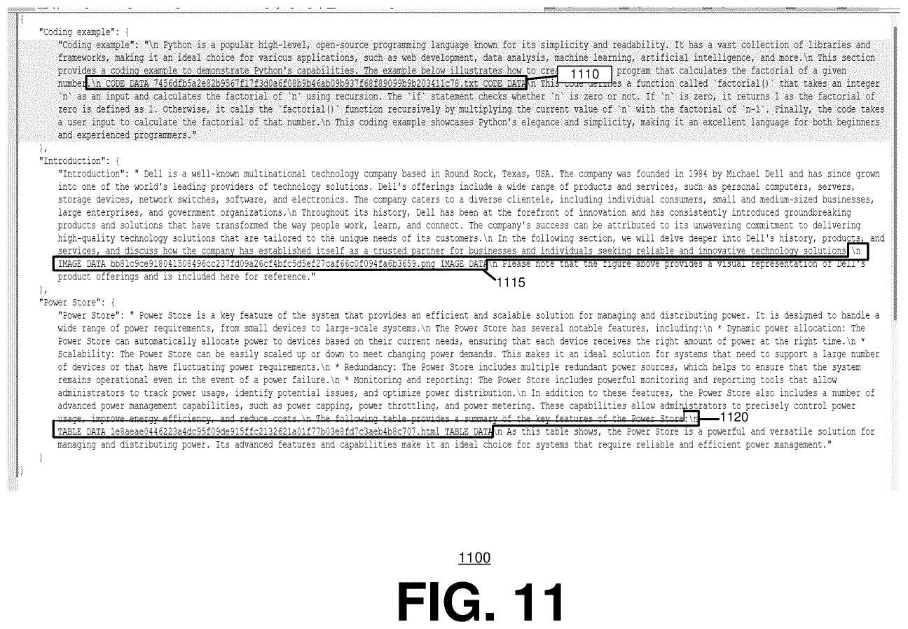

FIG. 11 illustrates an example template 1100 in a standardized format with placeholders. Code block placeholder 1110 may be indicative of a code block (e.g., lines of computer code) that may be referred to, or indicated by, the placeholder, but, according to at least one example embodiment, a learning model may not consider the placeholder as an input. Placeholder 1110 may comprise, for example, an address, or a file name, corresponding to storage of the code block code by computing storage equipment. Image placeholder 1115 may be indicative of an image (e.g., an image file) that may be referred to, or indicated by, by the placeholder, but, according to at least one example embodiment, a learning model may not consider the placeholder as an input. Placeholder 1115 may comprise, for example, an address, or a file name, corresponding to storage of the image by computing storage equipment. Table placeholder 1120 may be indicative of a table that may be referred to, or indicated by, by the placeholder, but, according to at least one example embodiment, a learning model may not consider the placeholder as an input. Placeholder 1120 may comprise, for example, an address, or a file name, corresponding to storage of the table by computing storage equipment. In an example embodiment, a computing system, as shown in FIG. 1, may read images from a text document, for example a .docx document, and name the images image1, image2 and so on. The place holders may facilitate rendering generated content in an original format with images corresponding to the image placeholders. Similarly, for code blocks, the computing system may read code blocks, which may be text, from a .docx format and determine, based on the writing style of the code block, that the style corresponds to computer code and not human-language text information. One or more determined code blocks may be saved as one or more corresponding text files-code block placeholders (e.g., ‘code block 1’, ‘code block 2’ and so on) may correspond to the determined code block text files. When rendering generated content in an original format based on a standardized version of the generated content (e.g., based on a JSON version of the generated content) the place holders may be replaced with the actual text from the text files indicated by the code block place holder(s). Thus, code block placeholders corresponding to determined code block(s) may facilitate rendering generated content in an original format with code block(s) corresponding to the code block placeholder(s). Similarly, with respect to table, for example, tables and contents thereof may be saved as, for example, one or more HTML files with placeholders indicative of the HTML files indicated in context content portions or in generated content portions for the tables. When service 135 renders standardized generated content in an original form, the table placeholder(s) may be replaced with actual HTML file information. Thus, a learning model may not use placeholders as input to the model, but placeholders facilitate the retaining of non-textual items as part of context content that is provided to the learning model and as part of a standardized form of generated content. Service 135 may use the placeholders to render the generated content in an original form that includes actual items or objects referred to by, or indicated by, the placeholders.

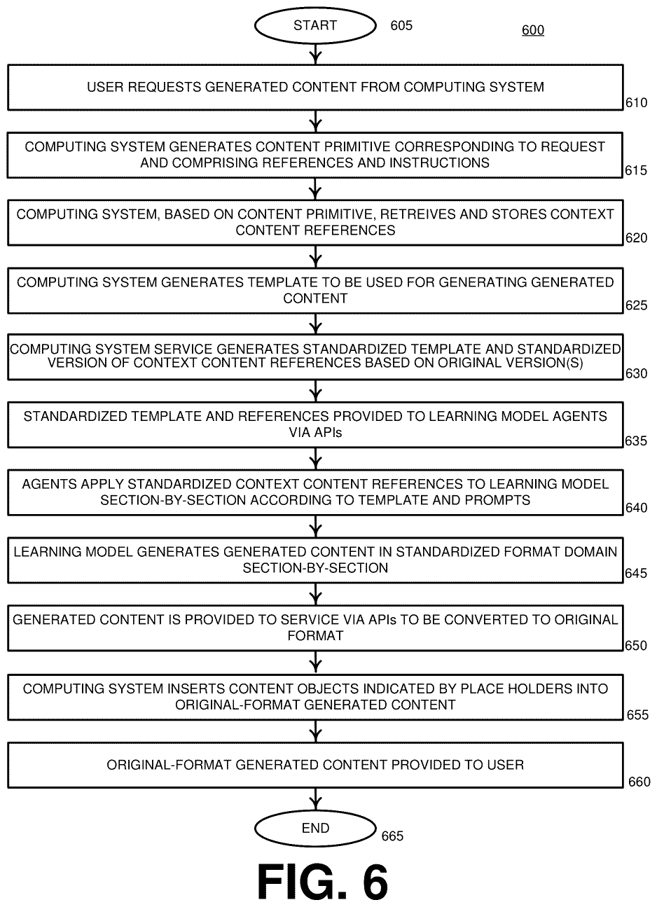

FIG. 6 illustrates a flow diagram of an example embodiment method 600. Method 600 begins at act 605. At act 610, a user may request generated content from a computing system. In response to the request made by the user at act 610, at act 615 the computing system may generate at least one content primitive corresponding to the request. The content primitive may comprise indication of references to be used to generate the content and the content primitive may comprise instructions that may be used as prompts for generating the requested generated content. At act 620, based on information contained in or indicated by the at least one content primitive, the computing system may retrieve and store context content reference information to computing storage equipment that may be communicatively coupled with, or that may be part of, the computing system. The context content reference information may be text information, image information, video information, table information, or other non-textual information. The context content reference information may comprise indications that are indicative of text information, image information, video information, table information or other non-textual information, or files containing such textual or non-textual information. The indications of the textual or non-textual information may comprise addresses, file names, paths, or other identifying information corresponding to storage of the textual or non-textual information by computing storage equipment.

At act 625, the computing system may generate a template to be used for generating the requested generated content. The template generated at act 625 may be based on a file, for example a text file, that may be indicated by the user at act 610 or that may be indicated by the content primitive. The template generated at act 625 may be generated in an original format that corresponds to text of a file upon which the template is based. For example, if a text file that is indicated to be used as a template is a .docx format file, the template generated at act 625 may be generated as a .docx file.

At act 630, the computing system using a service, for example JSON service described in reference to FIG. 1, may convert the template generated at act 625 into a standardized format template, for example the standardized format may comprise information corresponding to the template generated at act 625 saved according to a JSON key-value pair format. The standardized format may facilitate the template being passed to a learning model via at least one API. At act 630, the computing system may also convert at least one reference file, or information associated therewith, to the standardized format. For example, if the user at act 610 indicates three text files to be used by a learning model to generate the requested generated content, at act 630 the computing system may convert the three text files to the standardized (e.g., JSON) format. At act 635, the standardized format version of the template and the standardized format version of the at least one reference information may be passed to at least one learning model the at least one API. At least one placeholder may be included in the standardized format version of the at least one reference information to be indicative of at least one non-textual object, for example an image, a video, code block information, a table, and the like.

At act 640, the standardized format template and the standardized format reference information may be applied to at least one learning model by the computing system. At act 645, at least one learning model agent may facilitate generating content based on the standardized format reference information and at least one prompt that may have been passed from the content primitive to the at least one learning model. The at least one learning model may avoid generating generated content based on at least one placeholder that may be indicated in the standard format information. Reference information may be applied to the at least one learning model based on prompt information according to the standardized format version of the template on a section-by-section basis. For example, if the template generated at act 625 and thus the standardized format version of the template generated at act 630 is indicative that generated content should comprise four chapters with each chapter comprising three sections and each section comprising two subsections, the at least one learning model may generate content one subsection at a time to take advantage of a full amount of tokens (e.g., a learning model may have a total token limit associated therewith) for generation of each subsection. Thus, instead of generation of all generated content corresponding to all of the subsections being limited be a token limit corresponding to be at least one learning model, only generation of a subsection may be limited by a token limit corresponding to the at least one learning model.

At act 650, generated content corresponding to chapters, sections, subsections, and the like may be assembled according to the standardized format template. For example, if the standardized format template calls for four chapters with each chapter comprising three sections and each section comprising two subsections for a total of twenty four subsections, the twenty four subsections may be assembled into, or the standardized format template may be updated to comprise, each of the twenty four subsections as each of the subsections is generated by the at least one learning model. The generated content subsections that may be assembled into the standardized format template may be converted to an original format corresponding to the format corresponding to the template generated at act 630. At act 655, the computing system may insert objects, for example images, video clips, tables, computer code block examples, and the like, into the original-format generated content based on placeholders to result in a final version of the generated content requested at act 610. The final version of the generated content may be presented to, or may be provided to, the user that generated the request at act 610, and method 600 may advance to act 665 and to end.

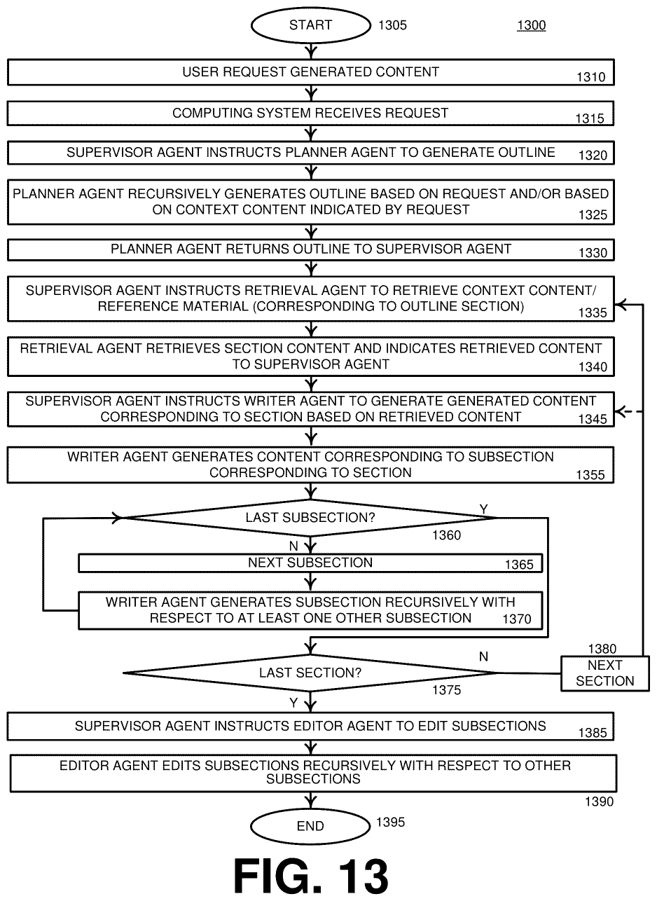

Turning now to FIG. 13, the figure illustrates an example method 1300. Method 1300 begins at act 1305. At act 1310, a user may request generated content, for example, via a request 105 as shown in FIG. 1. At act 1315, a computing system may receive a request for generated content requested at act 1310. Responsive to the request, the computing system may instantiate a supervisor agent and a planner agent. At act 1320, the supervisor agent may instruct the planner agent to generate an outline corresponding to the generated content requested at act 1310. At act 1325, the planner agent may recursively generate an outline that is based on, or that corresponds to, the request received at act 1315. The outline may be based on context content, or reference information, indicated by the request received at act 1315. In recursively generating the outline, the planner agent may recursively generate headings, subheadings, sub-subheadings, and so on that may correspond to sections, subsections, sub-subsections, and so on, of a document to be generated in response to the request received at act 1315. Information included in the request may be used to generate the headings, subheadings, sub sub-headings, etc. Information included in the request may be applied to at least one learning model. The at least one learning model may recursively and respectively generate a heading, subheading, sub-subheading and so on with respect to another heading, subheading, or sub-subheading wherein a previous and a subsequent heading, subheading, sub-subheading, etc., and the like are included as input prompts, along with information included in the request received at act 1315, to the at least one learning model. Thus, by recursively generating headings, subheadings, and sub-subheadings, the learning model may avoid subject matter overlap between headings, subheadings, and sub-subheadings. At act 1330, the planner agent may return a generated outline to the supervisor agent.

At act 1335, the computing system may instantiate, or may call, a retrieval agent that the computing system has already instantiated with respect to the request received at act 1310, and the supervisor agent may instruct the retrieval agent to retrieve context content information from computing storage equipment that may be part of, or that may be communicatively coupled with, the computing system. The context content information to be retrieved may be information indicated by the request received at act 1315. Context content information retrieved at act 1335 may be at least one actual file, for example a file comprising textual information. In an embodiment, context content information retrieved at act 1335 may be metadata corresponding to at least one actual file that may comprise textual information. In an embodiment, the supervisor agent may instruct the retrieval agent to retrieve context content information that corresponds to a single section, subsection, or sub-sub section, of generated content requested at act 1310. At act 1340, the retrieval agent may retrieve context content information indicated at act 1335 and may return the retrieved information to the supervisor agent.

At act 1345, the supervisor agent may instantiate a writer agent, or may instruct a writer agent that may have been previously instantiated, to generate content according to at least one outline section, subsection, or sub-subsection, as the case may be based on information that the supervisor agent instructed the retrieval agent to retrieve at act 1335. A writer agent may comprise a learning model, for example, a language learning model. At act 1355, the writer agent may generate content corresponding to a section, subsection, sub-sub-section, and the like. At act 1360, the supervisor agent may determine whether a section (or subsection, sub-subsection, sub-sub-subsection, etc., corresponding to a section, subsection, or sub-subsection, etc.) that the supervisor agent instructed the writer agent at act 1345 to generate is a last subsection of a section or a first sub-subsection of a subsection. For example, if the writer agent is generating a first sub-subsection 320A of section 315A shown in FIG. 3, method 1300 may advance to act 1365. At act 1365, supervisor agent may increment a counter, pointer, or other indicator indicative of a section, subsection, sub-subsection, and so on to indicate a next section, a next subsection, a next sub-subsection, etc. according to the outline indicated at act 1330. It will be appreciated that sub-subsection 320A and section 315A are referenced for example but that the same concept would apply if the outline, returned to the supervisor agent at act 1330, comprises sub-sub-subsections of sub-subsections and it will be appreciated that the same concept would apply to generation of content associated with a subsection of a section.

At act 1370, the writer agent may generate another section, subsection, sub-subsection, sub-sub subsection, etc. that may be at the same level as a previously generated subsection, sub-subsection, or sub-sub-subsection that may have been generated at act 1355 or at a previous iteration of act 1370. For example, the writer agent may generate generated content 320A (shown in FIG. 3) at act 1355 and the writer agent may generate content 320B-320n at act(s) 1370. The writer agent may generate content at act 1370 recursively. For example, after generating content 320A at act 1355, the writer agent may generate content 320B at act 1370, and the generating of content 320B may take into account content 320A to avoid, or to minimize, duplication of subject matter in generated content 320B and generated content 320A. Similarly, the writer agent may generate at act 1370 content 320C (not shown in FIG. 3) recursively with respect to content 320A or content 320B, and may then revise content 320B taking into account content 320A and content 320 C. It will be appreciated that a maximum number of tokens, a token maximum, or a token limit, may be associated with a learning model corresponding to the writer agent that may generate a section (or sub-subsection, or sub-sub-subsection, etc.). By generating a sub-subsection 320, a subsection 315, or a section 310 (shown in FIG. 3) one at a time, each section, subsection, sub-subsection, sub-sub-subsection, and the like may be independently generated with respect to other sections, subsections, sub-subsections, or sub-sub-subsections, and thus may be generated by the writer agent using a full amount of tokens that the learning model corresponding to the writer agent is capable of using to generate generated content. It will be appreciated that if an outline returned to the supervisor agent at act 1330 comprises only a single subsection with respect to a section, for example, method 1300 may advance from act 1360 to act 1375 and bypass act 1365 or act 1370.

Returning to description of act 1360, if a determination is made that a subsection corresponding to a section (or a sub-subsection corresponding to subsection, etc.) is a last subsection corresponding to the section (e.g., sub-subsection 320n is a last sub-subsection corresponding to subsection 315A), method 1300 may advance from act 1360 to act 1375.

At act 1375, the supervisor agent may determine whether a section (or subsection, subsubsection, or sub-sub-subsection, etc.) with respect to which the retrieval agent retrieved content at act 1340 is a last section (or subsection, subsubsection, or sub-sub-subsection, etc.) indicated by the outline returned at act 1330. If a determination is made at act 1375 that a section with respect to which context content was retrieved at 1340 is not a last section indicated by the outline returned to the supervisor agent at age 1330, method 1300 may advance to act 1380. At act 1380, the supervisor agent may increment a counter, pointer, or other indicator indicative of a next section (or subsection, sub-subsection, sub-sub-subsect, etc.). Method 1300 may return from act 1380 to act 1335, the supervisor agent may instruct the retrieval agent to retrieve context content information corresponding to the next section, indicated at act 1380, of the outline indicated at act 1330, and method 1300 may continue as described herein with respect to 1335. In an embodiment, if the supervisor agent at a previous iteration of act 1335 instructed the retrieval agent to retrieve all context content information corresponding to the request received at act 1315, method 1300 may return from act 1380 to act 1345 and method 1300 may continue as described herein with respect to act 1345.

Returning to description of act 1375, if a determination is made that a current section is a last section of an outline indicated to the supervisor agent at act 1830 (e.g., generated content has been generated with respect to all sections corresponding to the outline indicated to the supervisor agent), method 1300 may advance to act 1385. At act 1385, the supervisor agent may instantiate an editor agent, which may comprise at least one learning mode, and may instruct the editor agent, or a previously instantiated editor agent, to edit sections, subsections, subsubsections, or sub-sub-subsections, etc. recursively with respect to other sections, subsubsections, or sub-sub-subsections, etc. that may have been generated at at least one iteration of act 1355 or at at least one iteration of act 1370. As described in reference to act 1370, the editor agent may recursively edit, sections, subsections, subsubsections, or sub-sub-subsections, etc. recursively with respect to other sections, subsubsections, or sub-sub-subsections, etc. that may have been generated at least one iteration of act 1355 or at least one iteration of act 1370 such that, although due to recursive generation of generated content subject matter may not overlap from one section of generated content to another, from one subsection to another, from one sub-subsection to another, etc., language style or writing style may be smoothed to be similar from one subsection to another, from one sub-subsection to another, etc. Method 1300 may advance from act 1390 to act 1395 and end.

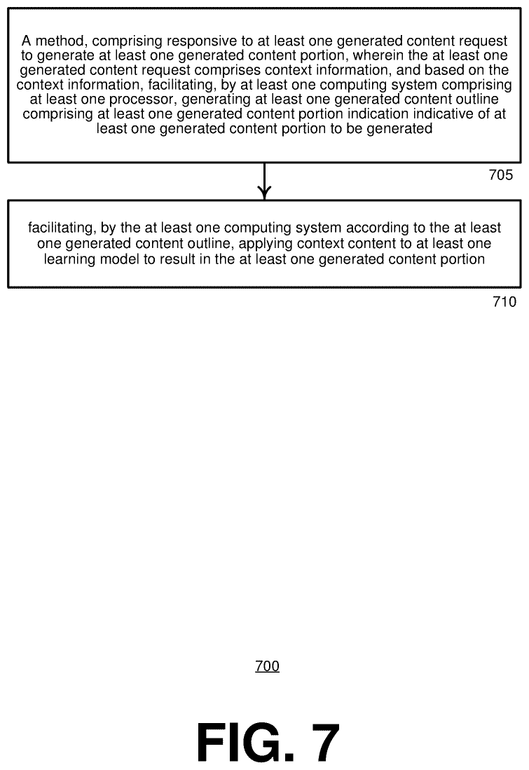

Turning now to FIG. 7, the figure illustrates an example method 700 comprising at block 705, responsive to at least one generated content request to generate at least one generated content portion, wherein the at least one generated content request comprises context information, and based on the context information, facilitating, by at least one computing system comprising at least one processor, generating at least one generated content outline comprising at least one generated content portion indication indicative of at least one generated content portion to be generated; and at block 710 facilitating, by the at least one computing system according to the at least one generated content outline, applying context content to at least one learning model to result in the at least one generated content portion.

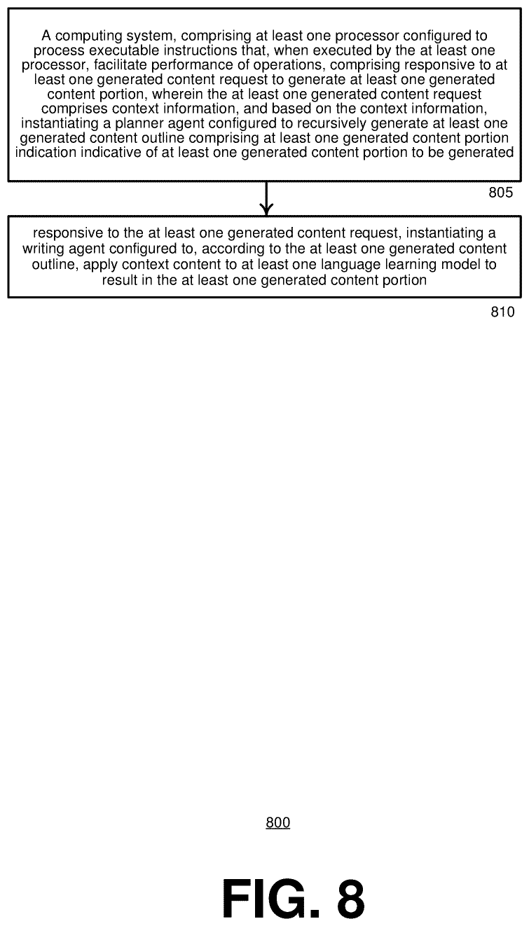

Turning now to FIG. 8, the figure illustrates am example computing system 800, comprising at block 805 at least one processor configured to process executable instructions that, when executed by the at least one processor, facilitate performance of operations, comprising, responsive to at least one generated content request to generate at least one generated content portion, wherein the at least one generated content request comprises context information, and based on the context information, instantiating a planner agent configured to recursively generate at least one generated content outline comprising at least one generated content portion indication indicative of at least one generated content portion to be generated; and at block 810 responsive to the at least one generated content request, instantiating a writing agent configured to, according to the at least one generated content outline, apply context content to at least one language learning model to result in the at least one generated content portion.

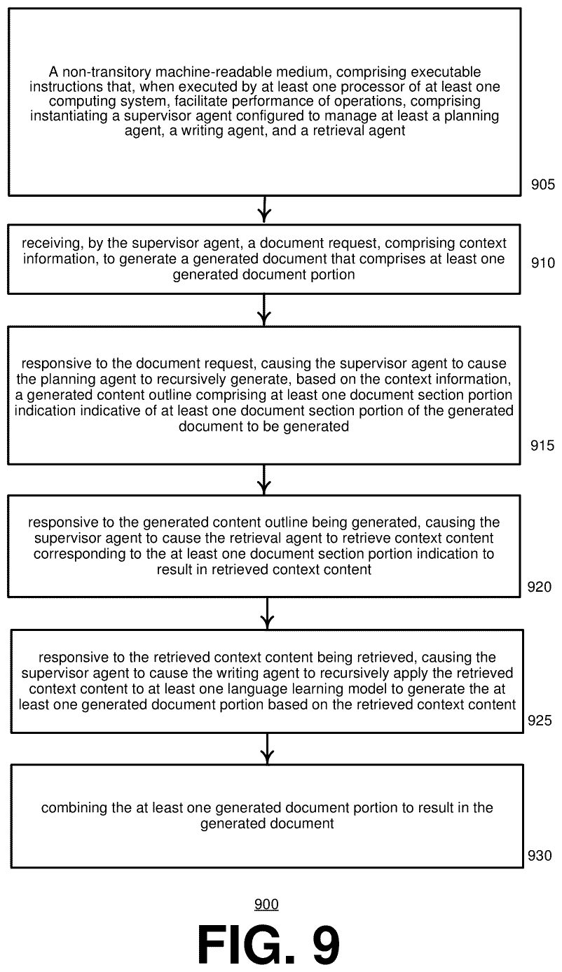

Turning now to FIG. 9, the figure illustrates non-transitory machine-readable medium 900, comprising at block 905 executable instructions that, when executed by at least one processor of at least one computing system, facilitate performance of operations, comprising, instantiating a supervisor agent configured to manage at least a planning agent, a writing agent, and a retrieval agent; at block 910 receiving, by the supervisor agent, a document request, comprising context information, to generate a generated document that comprises at least one generated document portion; at block 915 responsive to the document request, causing the supervisor agent to cause the planning agent to recursively generate, based on the context information, a generated content outline comprising at least one document section portion indication indicative of at least one document section portion of the generated document to be generated; at block 920 responsive to the generated content outline being generated, causing the supervisor agent to cause the retrieval agent to retrieve context content corresponding to the at least one document section portion indication to result in retrieved context content; at block 925 responsive to the retrieved context content being retrieved, causing the supervisor agent to cause the writing agent to recursively apply the retrieved context content to at least one language learning model to generate the at least one generated document portion based on the retrieved context content; and at block 930 combining the at least one generated document portion to result in the generated document.

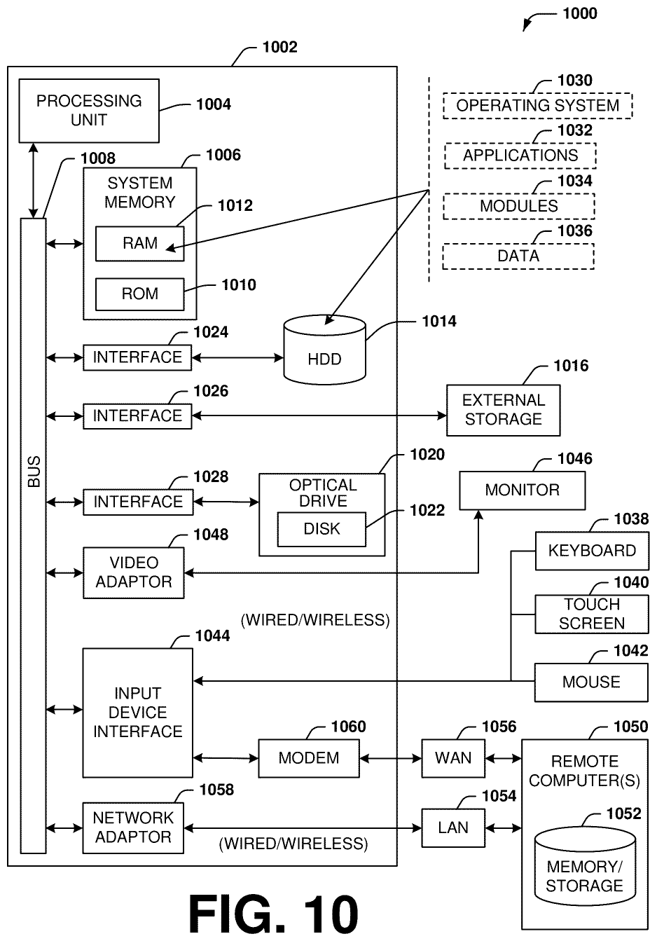

In order to provide additional context for various embodiments described herein, FIG. 10 and the following discussion are intended to provide a brief, general description of a suitable computing environment 1000 in which various embodiments of the embodiment described herein can be implemented. While embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors and may include a cache memory. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

Computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid-state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the . NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can comprise a security module, such as a trusted processing module (TPM). For instance, with a TPM, boot components hash next in time boot components, and wait for a match of results to secured values, before loading a next boot component. This process can take place at any layer in the code execution stack of computer 602, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” or variations thereof as may be used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
responsive to at least one generated content request to generate at least one generated content portion, wherein the at least one generated content request comprises context information, and based on the context information, facilitating, by at least one computing system comprising at least one processor, generating at least one generated content outline comprising at least one generated content portion indication indicative of at least one generated content portion to be generated; and
facilitating, by the at least one computing system according to the at least one generated content outline, applying context content to at least one learning model to result in the at least one generated content portion.

2. The method of claim 1, wherein the at least one generated content outline comprises a first generated content portion indicative of a first generated content portion to be generated and a second generated content portion indicative of a second generated content portion to be generated, wherein the at least one generated content portion comprises the first generated content portion and a second generated content portion, respectively corresponding to the first generated content portion to be generated and the second generated content portion to be generated, and wherein the at least one learning model is applied to the context content to result in the second generated content portion after the first generated content portion has been generated.

3. The method of claim 1, wherein the at least one generated content outline is generated recursively.

4. The method of claim 3, wherein the at least one generated content outline comprises at least one main level indication indicative of at least one generated main level section to be generated as at least one of the at least one generated content portion and at least one sublevel indication indicative of at least one generated sublevel section to be generated as at least one of the at least one generated content portion, wherein each of the at least one main level indication is generated recursively with respect to at least one other of the at least one main level indication, and wherein each of the at least one sublevel indication is generated recursively with respect to at least one other of the at least one sublevel indication.

5. The method of claim 4, wherein the at least one generated main level section and the at least one generated sublevel section are each generated according to a maximum token value corresponding to the at least one learning model.

6. The method of claim 1, further comprising:
based on the at least one generated content portion indication, facilitating, by the at least one computing system, determining the context content to be applied to the at least one learning model to result in at least one determined context content portion.

7. The method of claim 6, wherein, based on the at least one generated content request, the at least one determined context content portion is determined to respectively correspond to the at least one generated content portion indication.

8. The method of claim 1, further comprising:
further responsive to the at least one generated content request, facilitating, by the at least one computing system, combining the at least one generated content portion to result in at least one combined generated content portion.

9. The method of claim 8, further comprising:
facilitating, by the at least one computing system, recursively editing at least one of the at least one generated content portion corresponding to the at least one combined generated content portion with respect at least one other of the at least one generated content portion corresponding to the at least one combined generated content portion, to result in a recursively edited at least one combined generated portion.

10. The method of claim 9, wherein the recursively editing comprises:
reducing a size of at least one of the at least one generated content portion to result in at least one reduced size generated content portion; and
applying the at least one reduced size generated content portion and at least one other of the at least one generated content portion to the at least one learning model to result in at least one smoothed generated content portion,
wherein the at least one smoothed generated content portion is included in the at least one combined generated portion, and wherein the at least one reduced size generated content portion is not included in the at least one combined generated portion.

11. The method of claim 10, wherein the at least one of the at least one generated content portion comprises text, and wherein the reducing the size of the at least one of the at least one generated content portion comprises deleting at least one sentence of the text.

12. The method of claim 1, wherein the at least one generated content request comprises at least one size limit applicable to the at least one generated content portion.

13. A computing system, comprising at least one processor configured to process executable instructions that, when executed by the at least one processor, facilitate performance of operations, comprising:
responsive to at least one generated content request to generate at least one generated content portion, wherein the at least one generated content request comprises context information, and based on the context information, instantiating a planner agent configured to recursively generate at least one generated content outline comprising at least one generated content portion indication indicative of at least one generated content portion to be generated; and
responsive to the at least one generated content request, instantiating a writing agent configured to, according to the at least one generated content outline, apply context content to at least one language learning model to result in the at least one generated content portion.

14. The computing system of claim 13, wherein the writing agent is further configured to generated the at least one generated content portion recursively.

15. The computing system of claim 13, wherein the operations further comprise:
instantiating an editor agent configured to recursively edit the at least one generated content portion.

16. The computing system of claim 15, wherein the operations further comprise:
instantiating a retrieval agent configured to retrieve, from storage equipment corresponding to the at least on computing system, the context content according to the at least one generated content outline to result in retrieved context content and to forward the retrieved context content to the writing agent according to the at least one generated content outline.

17. A non-transitory machine-readable medium, comprising executable instructions that, when executed by at least one processor of at least one computing system, facilitate performance of operations, comprising:
instantiating a supervisor agent configured to manage at least a planning agent, a writing agent, and a retrieval agent;
receiving, by the supervisor agent, a document request, comprising context information, to generate a generated document that comprises at least one generated document portion;
responsive to the document request, causing the supervisor agent to cause the planning agent to recursively generate, based on the context information, a generated content outline comprising at least one document section portion indication indicative of at least one document section portion of the generated document to be generated;
responsive to the generated content outline being generated, causing the supervisor agent to cause the retrieval agent to retrieve context content corresponding to the at least one document section portion indication to result in retrieved context content;
responsive to the retrieved context content being retrieved, causing the supervisor agent to cause the writing agent to recursively apply the retrieved context content to at least one language learning model to generate the at least one generated document portion based on the retrieved context content; and
combining the at least one generated document portion to result in the generated document.

18. The non-transitory machine-readable medium of claim 17, wherein the at least one document section portion comprises at least one of: at least one chapter, at least one section, or at least one subsection.

19. The non-transitory machine-readable medium of claim 18, wherein the context information comprises at least one size limit to be applied by the writing agent in generating at least one of: the at least one chapter, the at least one section, or the at least one subsection.

20. The non-transitory machine-readable medium of claim 18, wherein each of the at least one of the at least one chapter, at least one section, or at least one subsection is generated according to a full token size capability of the at least one language learning model.
